(19) United States
(12) Patent Application Publication
(10) Pub. No.: US 2025/0073506 A1
(43) Pub. Date: Mar. 6, 2025

(54) BODY PART FEATURE TATTOO STENCIL

(71) Applicant: Alicia Neal, Phoenix, AZ (US)

(72) Inventor: Alicia Neal, Phoenix, AZ (US)

(21) Appl. No.: 18/240,469

(22) Filed: Aug. 31, 2023

(51) Int. Cl. A61Q 1/02

(52) U.S. Cl. CPC A61Q 1/025

(57) ABSTRACT

A tattoo stencil includes at least one flexible sheet having a realistic design of at least one body part feature thereon. The at least one flexible sheet is configured to be applied over at least one body part of a user, thereby transferring the realistic design of the at least one body part feature to the at least one body part. The realistic design can then be used as a guide and tattooed over to tattoo the at least one body part feature to the at least one body part.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of tattooing of existing art and more specifically relates to a tattoo stencil with a realistic design of a body part feature to aid in the tattooing of the body part feature to a body part.

### RELATED ART

Permanent makeup is a cosmetic technique that employs tattoos (permanent pigmentation of the dermis) as a means of producing designs that resemble makeup or groomed features, such as artificial eyebrows. Particularly, microblading is a tattooing technique which typically employs a small handheld tool made of several tiny needles, used to add semi-permanent pigment to the skin. Microblading/temporary tattooing of the eyebrows is generally used to create, enhance or reshape the eyebrow's appearance in both shape and color, and as such, defining a perfect shape is a very important step of the process. However, the accuracy needed specifically in microblading is especially important as hairstrokes are created using a blade to create fine slices in the skin. Due to this, it is of particular importance to ensure precision of hair strokes.

The nipple areola complex (NAC) refers to the anatomical structure comprising the nipple and the surrounding pigmented area called the areola. There are several reasons why the nipple areola complex may need to be removed. In some cases, it is done as part of a mastectomy, which is the surgical removal of the breast. Mastectomies are commonly performed to treat breast cancer or as a preventive measure in individuals at high risk for developing breast cancer.

After the removal of the nipple areola complex, there are different techniques for its reconstruction. The method chosen depends on various factors, including the individual's preferences and breast reconstruction goals. One particular technique involves areola tattooing. Areola tattooing involves using pigments to recreate the color and texture of the areola. Skilled tattoo artists or medical professionals specializing in areola tattooing perform this procedure to provide a realistic appearance.

However, there are difficulties involved with areola tattooing. For example, achieving a realistic three-dimensional appearance is challenging. Areolas have a complex texture and shading can be difficult to replicate through tattooing alone. While skilled tattoo artists can create the illusion of depth and dimension, it may not be as natural-looking as the original areola. In another example, expertise and technique of the practitioner play a significant role in achieving the desired outcome. Inadequate skill or improper techniques can lead to unsatisfactory results, such as uneven pigmentation, asymmetry, or an unnatural appearance.

Scalp micropigmentation (SMP) is a non-surgical cosmetic procedure that involves tattooing the scalp with tiny, specialized needles to create the illusion of hair follicles. It is primarily used as a solution for individuals experiencing hair loss, thinning hair, or baldness. During the SMP procedure, pigment is deposited into the superficial layers of the scalp, replicating the appearance of hair follicles at the desired density and color. This technique can be used to create the appearance of a closely shaved head, add density to thinning hair, camouflage scars, or create a defined hairline. As with any tattooing procedure, SMP is irreversible. Once the pigments are tattooed onto the scalp, it is challenging to remove or modify them. Therefore, it is crucial for a tattoo artist to be able to accurately replicate the desired hairline and density.

As such, a suitable solution is desired.

### SUMMARY OF THE INVENTION

In view of the foregoing disadvantages inherent in the known tattoo stencil art, the present disclosure provides a novel body part feature tattoo stencil. The general purpose of the present disclosure, which will be described subsequently in greater detail, is to provide a tattoo stencil that can be used for easily and consistently tattooing body part features onto body parts, such as eyebrows onto eyebrow regions, nipple-areola complexes onto breasts and hair follicles onto scalps. As such, the aforementioned problems existing in the current art are negated.

A tattoo stencil is disclosed herein. The tattoo stencil may include at least one flexible sheet configured to be applied over at least one body part of a user and having a realistic design printed thereon with stencil ink. Particularly, the realistic design may of at least one body part feature corresponding to the at least one body part. In some embodiments, the at least one body part feature may be chosen from the group consisting of an eyebrow, a nipple-areola complex, and one or more hair follicles. The stencil ink may be able to be transferred to the at least one body part of the user when the at least one flexible sheet is applied thereover, thereby transferring the realistic design to the at least one body part for use as a stencil during tattooing of the at least one body part.

According to another embodiment, a method of tattooing at least one body part feature on at least one body part is also disclosed herein. The method may comprise the steps of: creating a realistic design of the at least one body part feature; scanning the realistic design into a computing device; printing, from the computing device, the realistic design onto paper with printer ink; scanning the paper through a tattoo transfer machine; printing, from the tattoo transfer machine, the realistic design onto at least one flexible sheet with stencil ink; applying the at least one flexible sheet over the at least one body part to be tattooed; transferring the stencil ink onto the at least one body part such that the realistic design is applied to the at least one body part; removing the at least one flexible sheet from the at least one body part; and tattooing over the realistic design, thereby tattooing the at least one body part feature onto the at least one body part.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a body part feature tattoo stencil, constructed and operative according to the teachings of the present disclosure.

FIG. 1 is a top perspective view of a tattoo stencil having a realistic design printed thereon being applied over a body part of a user, according to an embodiment of the disclosure.

FIG. 2 is a top perspective view of the realistic design having been transferred to the body part of the user prior to tattooing, according to an embodiment of the disclosure.

FIG. 3 is a front view of the tattoo stencil and illustrating the realistic design being of a pair of eyebrows having a hair stroke pattern, according to an embodiment of the present disclosure.

FIG. 4 is a front view of a pair of eyebrows with another hair stroke pattern, according to another embodiment of the present disclosure.

FIG. 5 is a front view of a pair of eyebrows with another hair stroke pattern, according to another embodiment of the present disclosure.

FIG. 6 is a front view of a pair of eyebrows with another hair stroke pattern, according to another embodiment of the present disclosure.

FIG. 7 is a front view of a pair of eyebrows with another hair stroke pattern, according to another embodiment of the present disclosure.

FIG. 8 is a front view of a pair of eyebrows with another hair stroke pattern, according to another embodiment of the present disclosure.

FIG. 9 is a front view of a pair of eyebrows with another hair stroke pattern, according to another embodiment of the present disclosure.

FIG. 10 is a front view of a pair of eyebrows with another hair stroke pattern, according to another embodiment of the present disclosure.

FIG. 11 is a front view of the tattoo stencil and illustrating the realistic design being of a pair of nipple-areola complexes, according to an embodiment of the present disclosure.

FIG. 12 is a front view of the pair of nipple-areola complexes of FIG. 11 having another diameter, according to another embodiment of the present disclosure.

FIG. 13 is a front view of the pair of nipple-areola complexes of FIG. 11 having another diameter, according to another embodiment of the present disclosure.

FIG. 14 is a front view of a pair of nipple-areola complexes having a heart shape, according to another embodiment of the present disclosure.

FIG. 15 is a front view of the pair of nipple-areola complexes of FIG. 14 having a another diameter, according to another embodiment of the present disclosure.

FIG. 16 is a front view of the pair of nipple-areola complexes of FIG. 14 having another diameter, according to another embodiment of the present disclosure.

FIG. 17 is a front view of the tattoo stencil and illustrating the realistic design being of a plurality of hair follicles, according to an embodiment of the present disclosure.

FIG. 18 is a flow diagram illustrating a method of tattooing at least one body part feature on at least one body part, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a body part feature tattoo stencil. Generally, the body part feature tattoo stencil may be used for cosmetic purposes or for paramedical purposes. For example, the body part feature tattoo stencil may used for cosmetic tattooing, or for paramedical tattooing particularly for alopecia sufferers, breast cancer survivors, etc. The body part feature tattoo stencil may be used to transfer a realistic design of a body part feature, such as (but not limited to) an eyebrow, a nipple-areola complex, one or more hair follicles, etc., to a body part, such as (but not limited to) an eyebrow region, a breast, a scalp, etc. The body part feature tattoo stencil may provide a template, allowing tattoo artists to easily and consistently tattoo body part features onto body parts, and enabling easy training of new tattoo artists.

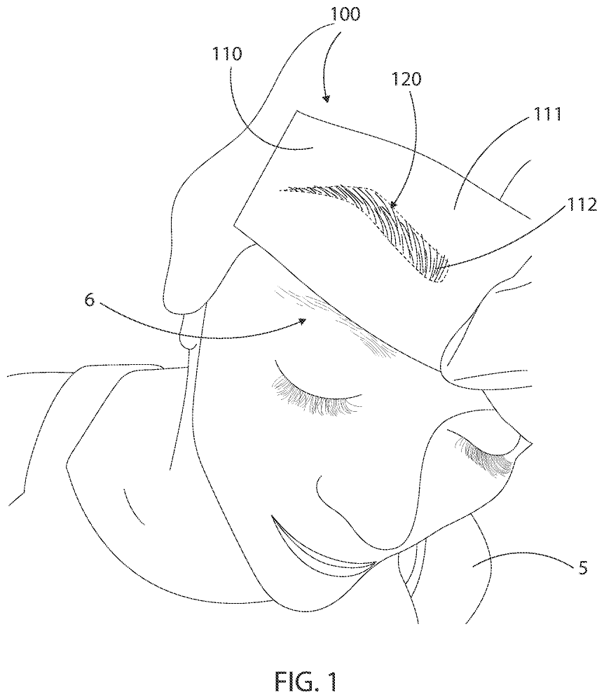

Referring now more specifically to the drawings by numerals of reference, there is shown in FIGS. 1-17, various views of a tattoo stencil 100.

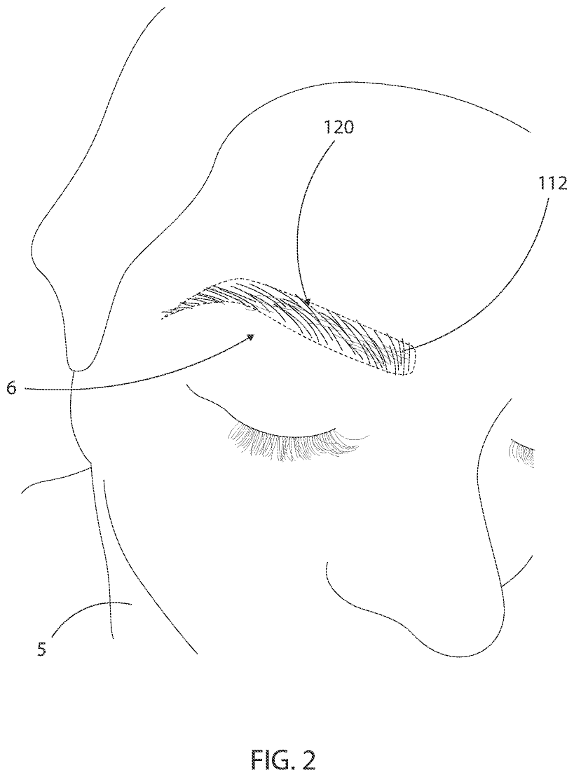

Referring first to FIGS. 1-2, the tattoo stencil 100 may include at least one flexible sheet 110 configured to be applied over at least one body part 6 of a user 5. The at least one flexible sheet 110 may include a realistic design 120 printed thereon with stencil ink 112. Particularly, the realistic design 120 may be of at least one body part feature corresponding to the at least one body part 6. For example, as shown in FIGS. 1-2, the at least one body part 6 may be at least one eyebrow region and the realistic design 120 may be of at least one eyebrow.

The stencil ink 112 may be able to be transferred to the at least one body part 6 of the user 5 when the at least one flexible sheet 110 is applied thereover, thereby transferring the realistic design 120 to the at least one body part 6 for use as a stencil during tattooing of the at least one body part 6. In some embodiments, the at least one flexible sheet 110 may include thermal carbon paper 111. Further, in some embodiments, the stencil ink 112 may be carbon ink. The carbon ink may be transferred to the at least one body part 6 when pressure, heat, moisture, combinations thereof, etc. are applied thereover.

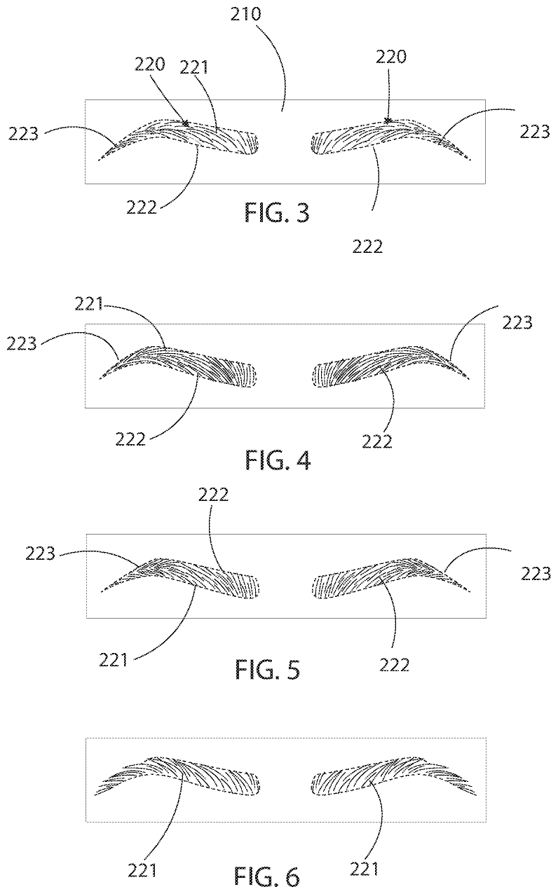

Referring now to FIGS. 3-10, there is shown various views of a flexible sheet 210 including a realistic design of at least one eyebrow 220 for application to at least one eyebrow region. It should be appreciated that whilst a single flexible sheet 210 per pair of eyebrows is shown and described here, a single flexible sheet 210 may include less or more than a pair of eyebrows thereon. Further, in some embodiments, a plurality of pairs of eyebrows may be provided on a single flexible sheet 210.

As shown, the at least one eyebrow 220 may include a hair stroke pattern 221. The hair stroke patterns may range from classic, downward and upward patterns and may mimic natural hair growth within eyebrows. FIGS. 3-10 illustrate various hair stroke patterns 221 contemplated; however, it should be appreciated that the present invention is not limited to the designs shown in the figures and described here. Further, it is contemplated that the tattoo stencil 100 may be used for microblading, shading, nano brows, etc.

Referring first to FIG. 3, there is shown a ‘classic’ hair stroke pattern 221. Particularly, the hair stroke pattern 221 may include natural upward strokes and an early transition into a body 222 of the at least one eyebrow 220, creating a soft ‘Christmas tree’ tail end 223 of the at least one eyebrow 220. This particular design may be used for microblading and shading.

Referring now to FIG. 4, there is shown another classic hair stroke pattern 221 which may particularly include dense natural upward strokes and an early transition into the body 222 of the at least one eyebrow 220, creating a soft ‘Christmas tree’ tail end 223 of the at least one eyebrow 220. This particular design may be used for microblading.

Referring now to FIG. 5, there is shown another classic hair stroke pattern 221. This design may resemble either one of the hair stroke patterns 221 shown in FIG. 3 and FIG. 4, depending on user preference. Particularly, the hair stroke pattern 221 may include upward natural strokes with an early transition into the body 222 of the at least one eyebrow 220 and may create a soft ‘Christmas tree’ tail end 223. This design may be used in microblading or shading and may provide the user/artist with creativity to go dense or create a combination eyebrow.

Referring now to FIG. 6, there is shown an upward hair stroke pattern 221. Particularly, this design may include clusters of upward hair strokes, creating a fluffy eyebrow. This may be particularly suited for use on larger eyebrows and used in microblading or shading.

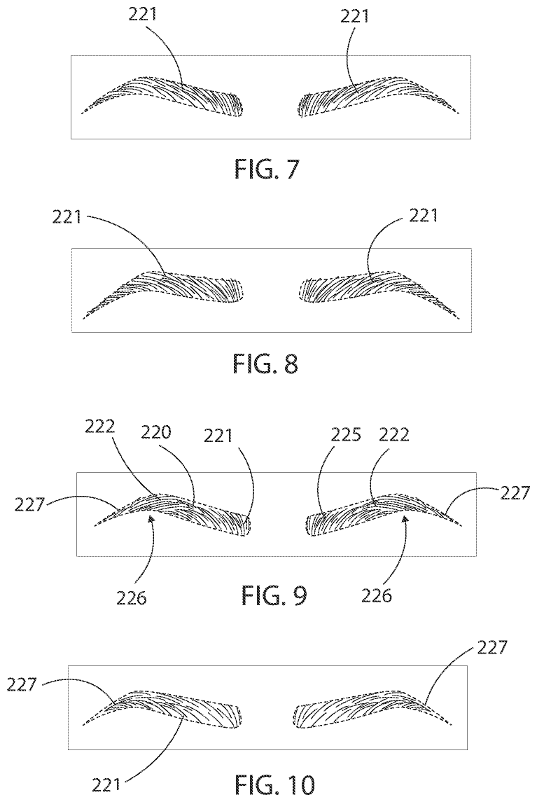

Referring now to FIG. 7, there is shown another upward hair stroke pattern 221. This design may include upward strokes of evenly spaced groupings of hair, creating a light feathered effect. This design may be used for microblading or shading.

Referring now to FIG. 8, there is shown another upward hair stroke pattern 221. This design may include upward and outward individual strokes. Similar to the hair stroke pattern 221 shown in FIG. 6, this design may be particularly suited for use on larger eyebrows and used in microblading or shading.

Referring now to FIG. 9, there is shown a combination upward and downward hair stroke pattern 221. Particularly, this design may include upward strokes starting at a head 225 of the at least one eyebrow 220, slightly curving into a downward or ‘rainbow’ configuration 226 through the body 222 of the at least one eyebrow 220 and into a downward tail 227. This design may be used for microblading or shading.

Referring now to FIG. 10, there is shown another combination upward and downward hair stroke pattern 221. Particularly, this design may include natural upward strokes that transition into a downward waterfall tail 228. This design may be used for microblading or shading.

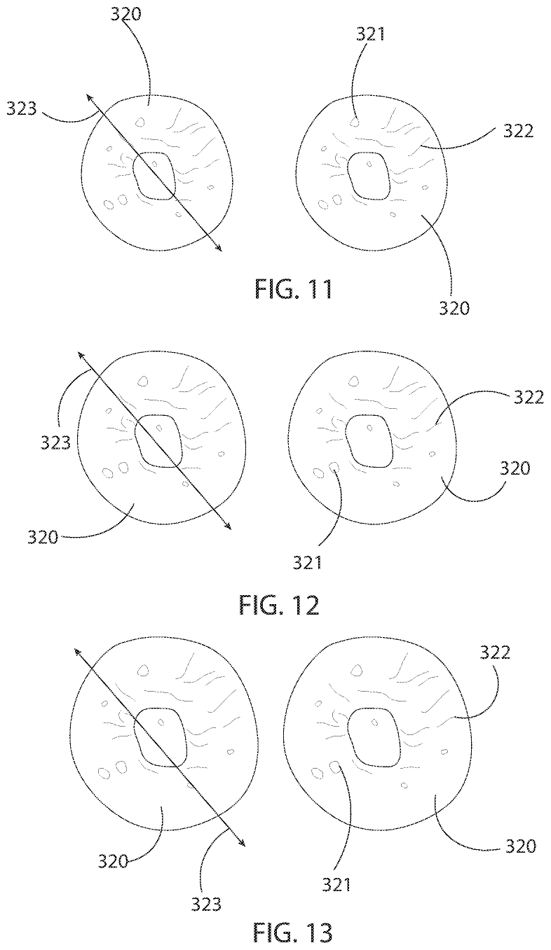

Referring now to FIGS. 11-16, there is shown various views of the realistic design being of at least one nipple-areola complex 320. As such, in this embodiment the at least one body part may be at least one breast. Again, as above, it should be appreciated that whilst a single flexible sheet 310 per pair of nipple-areola complexes 320 is shown and described here, one flexible sheet 310 may include less or more than a pair of nipple-areola complexes 320 thereon. Further, in some embodiments, a plurality of pairs of nipple-areola complexes 320 may be provided on a single flexible sheet 310.

As shown in these figures, the realistic design of the at least one nipple-areola complex 320 may further include at least one Montgomery gland 321 and at least one skin line 322. These features may be added to further resemble a realistic nipple-areola complex. As shown in FIGS. 11-13, in some embodiments, the nipple-areola complex 320 may include a circular shape, again resembling a typical nipple-areola complex. The realistic design may be provided in a variety of diameters 323.

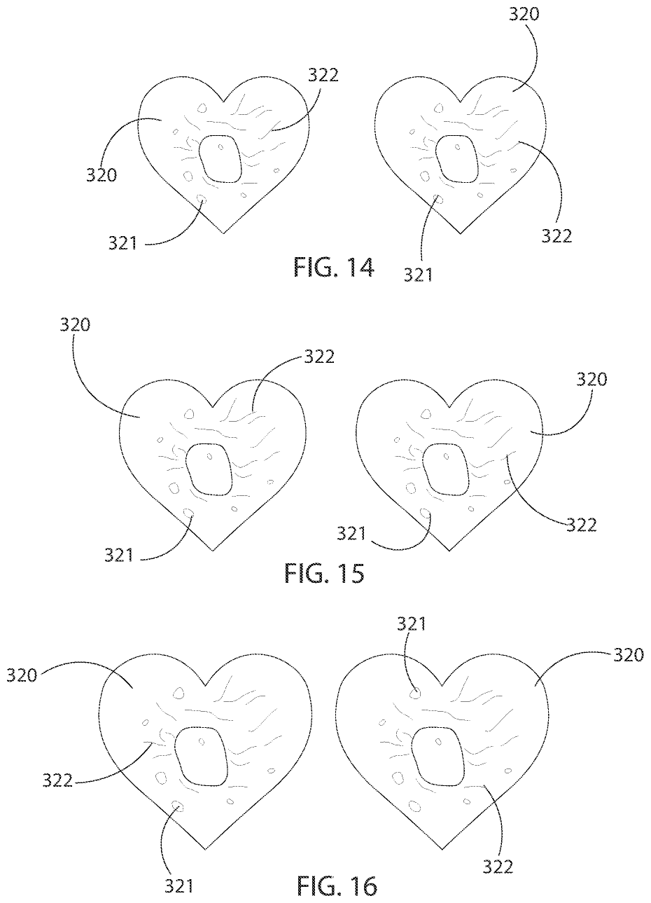

It should be appreciated that the realistic design of the nipple-areola complex 320 is not limited to being circular. Other shapes may be contemplated. For example, as shown in FIG. 14-16, the nipple-areola complex 320 may include a heart shape.

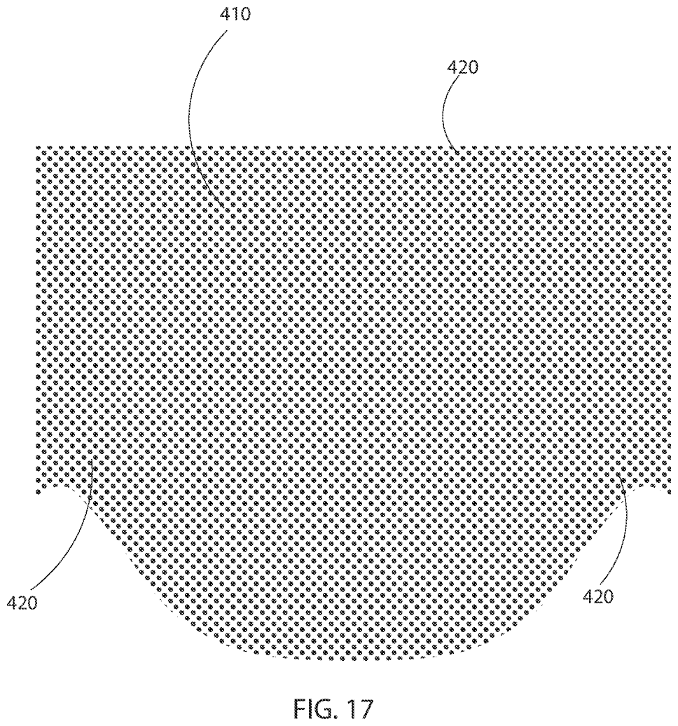

Referring now to FIG. 17, there is shown a view of a flexible sheet 410 including a realistic design of a plurality of hair follicles 420, according to another embodiment of the present invention. In this embodiment, the at least one body part may be a scalp. Particularly, as shown, the plurality of hair follicles 420 may include a plurality of dots spaced to help guide an artist to create a proper technique quickly. This particularly design may be useful for Scalp Micropigmentation (SMP). Further, some embodiments, this design may also include a ruler (not illustrated) to help the artist measure a hairline of the user 5.

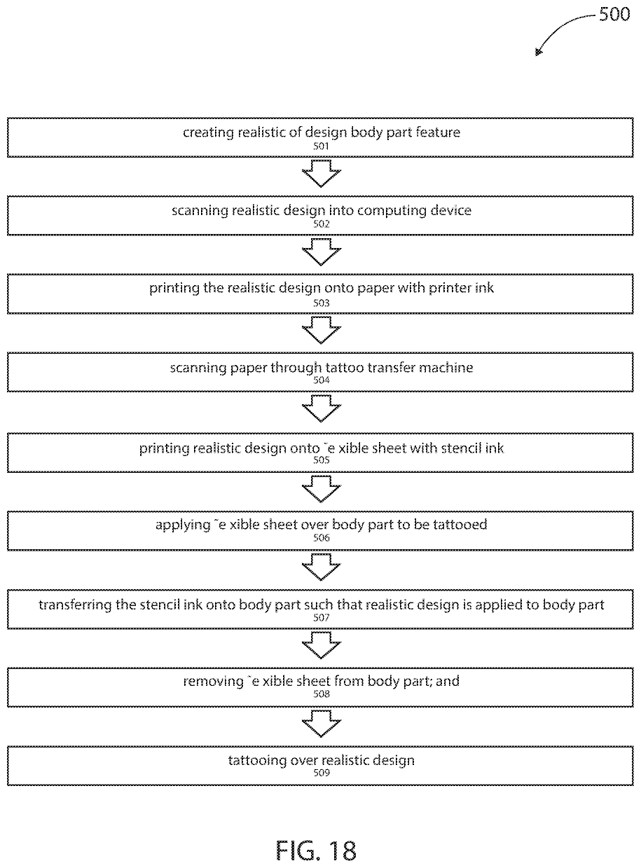

Referring now to FIG. 18 showing a flow diagram illustrating a method 500 method of tattooing at least one body part feature on at least one body part, according to an embodiment of the present disclosure. In particular, the method 500 may include one or more components or features of the tattoo stencil 100 as described above.

As illustrated in FIG. 18, the method 500 may include the steps of: step one 501, creating a realistic design of the at least one body part feature; step two 502, scanning the realistic design into a computing device; step three 503, printing, from the computing device, the realistic design onto paper with printer ink; step four 504, scanning the paper through a tattoo transfer machine; step five 505, printing, from the tattoo transfer machine, the realistic design onto at least one flexible sheet with stencil ink; step six 506, applying the at least one flexible sheet over the at least one body part to be tattooed; step seven 507, transferring the stencil ink onto the at least one body part such that the realistic design is applied to the at least one body part; step eight 508, removing the at least one flexible sheet from the at least one body part; and step nine 509, tattooing over the realistic design, thereby tattooing the at least one body part feature onto the at least one body part. As above, in some embodiments pressure, heat, water, etc. may be applied over the at least one flexible sheet when attached over the at least one body part to help transfer the stencil ink to the at least one body part.

It should be noted that the steps described in the method of use can be carried out in many different orders according to user preference. The use of “step of” should not be interpreted as “step for”, in the claims herein and is not intended to invoke the provisions of 35 U.S.C. § 112 (f). It should also be noted that, under appropriate circumstances, considering such issues as design preference, user preferences, marketing preferences, cost, structural requirements, available materials, technological advances, etc., other methods are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tattoo stencil comprising:
at least one flexible sheet configured to be applied over at least one body part of a user, the at least one flexible sheet including:
a realistic design printed thereon with stencil ink, the realistic design of at least one body part feature corresponding to the at least one body part, the stencil ink able to be transferred to the at least one body part of the user when the at least one flexible sheet is applied thereover, thereby transferring the realistic design to the at least one body part for use as a stencil during tattooing of the at least one body part.

2. The tattoo stencil of claim 1, wherein the at least one flexible sheet includes thermal carbon paper.

3. The tattoo stencil of claim 1, wherein the stencil ink is carbon ink.

4. The tattoo stencil of claim 1, wherein the at least one body part is at least one eyebrow region, and wherein the realistic design is of at least one eyebrow having a hair stroke pattern.

5. The tattoo stencil of claim 4, wherein the hair stroke pattern includes natural upward strokes and an early transition into a body of the at least one eyebrow, creating a soft tail end of the at least one eyebrow.

6. The tattoo stencil of claim 4, wherein the hair stroke pattern includes dense natural upward strokes and an early transition into a body of the at least one eyebrow, creating a soft tail end of the at least one eyebrow.

7. The tattoo stencil of claim 4, wherein the hair stroke pattern includes clusters of upward hair strokes, creating a fluffy eyebrow.

8. The tattoo stencil of claim 4, wherein the hair stroke pattern includes upward strokes of evenly spaced groupings of hair, creating a light feathered effect.

9. The tattoo stencil of claim 4, wherein the hair stroke pattern includes upward and outward individual strokes.

10. The tattoo stencil of claim 4, wherein the hair stroke pattern includes upward strokes starting at a head of the at least one eyebrow, slightly curving into a rainbow configuration through a body of the at least one eyebrow and into a downward tail.

11. The tattoo stencil of claim 4, wherein the hair stroke pattern includes natural upward strokes that transition into a downward waterfall tail.

12. The tattoo stencil of claim 1, wherein the at least one body part is at least one breast, and wherein the realistic design is of at least one nipple-areola complex.

13. The tattoo stencil of claim 12, wherein the realistic design of the at least one nipple-areola complex further includes at least one Montgomery gland and at least one skin line.

14. The tattoo stencil of claim 13, wherein the realistic design of the at least one a nipple-areola complex includes a diameter of between 1.5-2 inches.

15. The tattoo stencil of claim 1, wherein the at least one body part is a scalp, and wherein the realistic design is of a plurality of hair follicles.

16. A tattoo stencil comprising:
at least one flexible sheet configured to be applied over at least one body part of a user, the at least one flexible sheet including:
a realistic design printed thereon with carbon ink, the realistic design of at least one body part feature corresponding to the at least one body part and chosen from the group consisting of an eyebrow, a nipple-areola complex, and a hair follicle, the carbon ink able to be transferred to the at least one body part of the user when the at least one flexible sheet is applied thereover, thereby transferring the realistic design to the at least one body part for use as a stencil during tattooing of the at least one body part.

17. The tattoo stencil of claim 16, wherein the at least one body part is at least one eyebrow region, and wherein the realistic design is of at least one eyebrow having a hair stroke pattern.

18. The tattoo stencil of claim 16, wherein the at least one body part is at least one breast, and wherein the realistic design is of at least one nipple-areola complex including at least one of at least one Montgomery gland and at least one skin line.

19. The tattoo stencil of claim 16, wherein the at least one body part is a scalp, and wherein the realistic design is of a plurality of hair follicles.

20. A method of tattooing at least one body part feature on at least one body part, the method comprising the steps of:
creating a realistic design of the at least one body part feature;
scanning the realistic design into a computing device;
printing, from the computing device, the realistic design onto paper with printer ink;
scanning the paper through a tattoo transfer machine;
printing, from the tattoo transfer machine, the realistic design onto at least one flexible sheet with stencil ink;
applying the at least one flexible sheet over the at least one body part to be tattooed;
transferring the stencil ink onto the at least one body part such that the realistic design is applied to the at least one body part;
removing the at least one flexible sheet from the at least one body part; and, tattooing over the realistic design, thereby tattooing the at least one body part feature onto the at least one body part.
